(19) United States
(12) Patent Application Publication
(10) Pub. No.: US 2026/0106448 A1
(43) Pub. Date: Apr. 16, 2026

(54) RADIO ACCESSORY FAIL-SAFE CIRCUIT USING PASSIVE COMPONENTS

(71) Applicant: MOTOROLA SOLUTIONS, INC., Chicago, IL (US)

(72) Inventors: Joo Yih See, Alor Setar (MY); Muhammad Nor AL-Hafiz Bin Abu Bakri, Nibong Tebal (MY); Trukesh Nadarajan, Seberang Jaya (MY); Wan Sabrina Wan Long, Tanjung Tokong (MY); Chen Kok Yeoh, Bukit Mertajam (MY); Yusasmadi Yusof, Butterworth (MY)

(21) Appl. No.: 18/917,442

(22) Filed: Oct. 16, 2024

(51) Int. Cl. H02H 3/20; H04B 1/40

(52) U.S. Cl. CPC H02H 3/20; H04B 1/40

(57) ABSTRACT

A device may include an accessory input for the radio accessory. A device may include an electrical ground. A device may include a fail-safe circuit coupled between the accessory input and the electrical ground, wherein the fail-safe circuit consists of passive components including. A device may include an AC filter coupled to the accessory input. A device may include a load switch circuit configured to couple the accessory input to the electrical ground when activated. A device may include a voltage control circuit coupled to the AC filter and the load switch circuit, and configured to activate the load switch circuit when a DC voltage on the accessory input exceeds a threshold.

### BACKGROUND

Public safety and other organizations use communication networks and portable electronic devices to facilitate communication among their members. Some of these devices operate using multiple frequency bands, including in the Land Mobile Radio (LMR) and Long-Term Evolution (LTE) bands. In some operating environments, such devices must comply with applicable regulations.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments of concepts that include the claimed invention, and to explain various principles and advantages of those embodiments.

FIG. 1 schematically illustrates a system for protecting a radio accessory according to some examples.

FIG. 2 schematically illustrates a remote speaker microphone, according to some examples.

FIG. 3 is a flowchart illustrating a method for protecting a radio accessory, according to some examples.

Skilled artisans will appreciate that elements in the figures are illustrated for simplicity and clarity and have not necessarily been drawn to scale. For example, the dimensions of some of the elements in the figures may be exaggerated relative to other elements to help improve understanding of embodiments of the present disclosure.

The system, apparatus, and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION OF THE INVENTION

The communication devices (e.g., two-way radios) and their accessories are used in rugged environments (e.g., public safety) and built to function for many years. However, over time, newer models are released, including new accessories. It is desirable to save costs and maximize the efficiency of newer accessories by ensuring backward compatibility to existing radios.

In some cases, parameters or standards change for newer radios, which could cause disruption if used with existing radios. For example, existing radios may be unable to prevent or detect DC voltage flows through newer 16 Ω remote speaker microphone (RSM) accessory speakers during the fault case, which could lead to thermal failure. European Union ATEX (ATmosphères EXplosibles) directives describe the minimum safety requirements for workplaces and equipment used in explosive atmospheres. Some ATEX directives require a redundant supply line for the fault case operation. In a fault case, the supply from V_{BUS} alone is not available to power up a conventional voltage detection circuit to trigger the protection mechanism for the remote speaker microphone. Where V_{BUS} is not present (prior to proper accessory attachment to the radio), from the ATEX perspective, this also can be considered as fault condition because there is no scheme and/or circuit to limit the speaker path exposure to maximum (DC higher threshold) fault condition at this stage.

Thus, there exists a need for an improved technical method, device, and system for mitigating fault conditions in the communication devices and meeting applicable regulatory requirements, including the ATEX directives.

Using the examples and aspects presented herein, remote speaker microphones and other radio accessory devices may be protected with a standalone sensing fail-safe circuit, which is self-powered using fault V_{DC} voltage occurring at the protected lines. Examples presented herein use a direct current voltage (V_{DC}) sense circuit without any active components (e.g., op-amp, comparators, and the like) to provide a fail-safe circuit for existing radio output lines, which require protection, e.g., an existing RSM Speaker +ve/−ve output line of the radio.

Examples presented herein feature circuits comprising passive components and do not require a dedicated voltage supply to power up. Such circuits are placed at the front stage of speaker line-up from radio to act as a protection for any protected components of a connected radio accessory device.

Example embodiments include an AC filter, a voltage control circuit, and a load switch. The AC filter allows V_{DC} voltage to pass through to enable the load switch to sink protected lines to ground when the level meets or exceeds a threshold. Sinking the protected lines to ground triggers protective circuits (e.g., a fuse) present in the radio, stopping the output. The filter suppresses audio frequency signals to prevent false triggering of the protection mechanism during the normal operations. The voltage control is tuned to determine the sensitivity level of the load switch, protecting the lines. Because the protection circuit requires no active circuit components, such as op amps, comparators, or Micropower Shunt Voltage References, it consumes no current and preserves battery life for the radio while also protecting from thermal overload.

In some aspects, the techniques described herein relate to a system for protecting a radio accessory, the system including: an accessory input for the radio accessory; an electrical ground; and a fail-safe circuit coupled between the accessory input and the electrical ground; wherein the fail-safe circuit consists of passive components including: an AC filter coupled to the accessory input; a load switch circuit configured to couple the accessory input to the electrical ground when activated; and a voltage control circuit coupled to the AC filter and the load switch circuit, and configured to activate the load switch circuit when a DC voltage on the accessory input exceeds a threshold.

In some aspects, the techniques described herein relate to a remote speaker microphone, the remote speaker microphone including: an input for coupling the remote speaker microphone to a radio; an electrical ground; and a fail-safe circuit coupled between the input and the electrical ground; wherein the fail-safe circuit consists of passive components including: an AC filter coupled to the input; a load switch circuit configured to couple the input to the electrical ground when activated; and a voltage control circuit coupled to the AC filter and the load switch circuit, and configured to activate the load switch circuit when a DC voltage on the input exceeds a threshold.

Each of the above-mentioned embodiments will be discussed in more detail below, starting with example system and device architectures of the system in which the embodiments may be practiced, followed by an illustration of processing blocks for achieving an improved technical method, device, and system for fail-safe protection of communication devices and accessories.

Using the examples provided herein, thermal failure can be prevented using a circuit consisting of passive components, which is powered by the fault voltage itself, and does not require a V_{BUS} voltage source. Such embodiments may be used to protect remote speaker microphones and other lines, which require protection from thermal overload (e.g., GPIO lines).

Example embodiments are herein described with reference to flowchart illustrations and/or block diagrams of methods, apparatus (systems) and computer program products according to example embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a special purpose and unique machine, such that the instructions, which execute via the processor of the computer or other programmable data processing apparatus, create means for implementing the functions/acts specified in the flowchart and/or block diagram block or blocks. The methods and processes set forth herein need not, in some embodiments, be performed in the exact sequence as shown and likewise various blocks may be performed in parallel rather than in sequence. Accordingly, the elements of methods and processes are referred to herein as “blocks” rather than “steps.”

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus that may be on or off-premises, or may be accessed via the cloud in any of a software as a service (SaaS), platform as a service (PaaS), or infrastructure as a service (IaaS) architecture so as to cause a series of operational blocks to be performed on the computer or other programmable apparatus to produce a computer implemented process such that the instructions which execute on the computer or other programmable apparatus provide blocks for implementing the functions/acts specified in the flowchart and/or block diagram block or blocks. It is contemplated that any part of any aspect or embodiment discussed in this specification can be implemented or combined with any part of any other aspect or embodiment discussed in this specification.

Further advantages and features consistent with this disclosure will be set forth in the following detailed description, with reference to the figures.

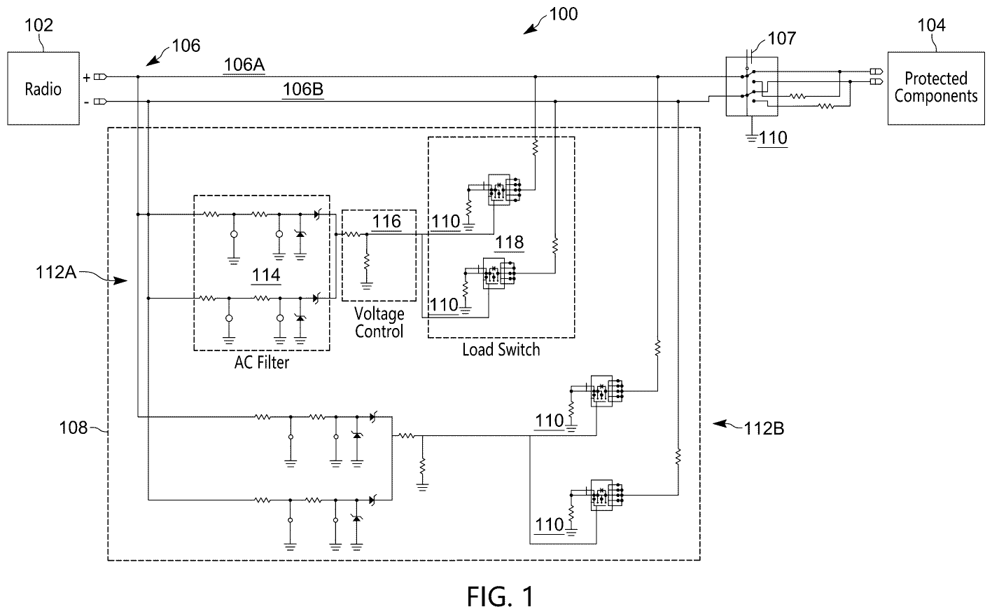

Referring now to the drawings, and in particular FIG. 1, an example system 100 is provided. The system 100 is an example system for protecting a radio accessory. In the illustrated example, the system 100 includes a radio 102 coupled to protected components 104 via an accessory input 106. The radio 102 may be, for example, a two-way land mobile radio (LMR). The protected components 104 coupled to the radio 102 may be one or more inductive and/or resistive loads, for example, a remote speaker microphone, a body-worn camera, a sensor, a light, or a siren. In some instances, the protected components 104 may be part of an adapter device for coupling a radio 102 to a second radio accessory.

As illustrated in FIG. 1, the accessory input 106 may include multiple input lines. As illustrated in FIG. 1, the accessory input 106 includes a first input line 106A and a second input line 106B. The accessory input 106 receives power and signals from the 102, for example, having both AC and DC components. In some instances, the accessory input 106 may couple the radio 102 to the protected components 104 through active or passive intervening circuitry 107 (e.g. a selector switch, an amplifier, or other suitable components).

The system 100 includes a fail-safe circuit 108, which is coupled to the accessory input 106 and an electrical ground 110. In some embodiments, the fail-safe circuit 108 includes redundant components. For example, as illustrated in FIG. 1, the fail-safe circuit 108 may be comprised of two fail-safe sub circuits 112A, 112B. In the example embodiment, the first fail-safe sub circuit 112A is coupled to the first input line 106A and the second fail-safe sub circuit 112B is coupled to the second input line 106B. Both the first and second fail-safe sub circuits 112A, 112B are also coupled to both the first and second input lines 106A, 106B. In this way, each of the input lines making up the accessory input 106 may be monitored. During fail-safe operation of the fail-safe circuit 108 (e.g., one or more fail-safe sub circuits) shunt one or both input lines 106A, 106B to the ground 110 under specified conditions, as described herein.

In some instances, the accessory input 106 may include more than two input lines. For example, an accessory input may also include one or more data (e.g., GPIO) lines, one or more DC power lines (e.g., a V_{BUS} for powering aspects of a connected accessory), and the like. In such instances, the data and power lines may also be coupled to respective fail-safe sub circuits.

The first fail-safe sub circuit 112A includes an AC filter 114, a voltage control circuit 116, and a load switch 118. The AC filter 114 may be, as illustrated in FIG. 1, a passive low pass RC filter configured to filter our AC signals on the accessory input 106. The AC filter 114 is configured to pass only the DC voltage present on the accessory input 106 to the voltage control circuit 116. For example, the accessory input 106 may include an audio input and, in such examples, the AC filter is configured to filter audio frequencies received from a radio coupled to the accessory input 106. In some examples, the DC voltage present on the accessory input 106 is the DC voltage between the first input line 106A and the second input line 106B. In some examples, the DC voltage present on the accessory input 106 is the DC voltage between accessory input 106 and the ground 110.

The voltage control circuit 116 includes a voltage divider. The Vᵢₙ of the voltage control circuit 116 is the DC voltage present on the accessory input 106, which has been passed to the voltage control circuit 116 by the AC filter 114. The Vₒᵤₜ of the voltage control circuit 116 is determined by the ratio of the resistors comprising the voltage control circuit 116. The resistors are configured to output a value for Vₒᵤₜ that will not trigger the load switch 118 while the value for Vᵢₙ is below a threshold voltage. In one example, the threshold voltage is selected to prevent damage to the protected components 104 by excessive DC voltage on the accessory input 106. In some instances, the threshold is based on a thermal limit for one or more of the protected components 104. In some instances, the thermal limit is set based on applicable regulations or standards (e.g., to comply with one or more of the ATEX directives).

When Vᵢₙ is below a threshold voltage, the voltage control circuit 116 produces a Vₒᵤₜ sufficient to trigger the load switch 118 to shunt the accessory input 106 to ground 110 (e.g., preventing a thermal overload of the protected components 104. The load switch 118 receives an input the Vₒᵤₜ from the voltage control circuit 116. In some examples, the load switch 118 is coupled between the accessory input 106 and the ground 110. In the illustrated example, the load switch 118 includes two N-channel Metal-Oxide-Semiconductor Field-Effect Transistors (N-Channel MOSFETs), each coupled to one of the input lines 106A, 106B of the accessory input 106. As illustrated, the source of each of the N-Channel MOSFETs is coupled to ground, while the drain is coupled to the respective input line through a pull-up resistor. The voltage control circuit 116 is coupled to the gate of each N-Channel MOSFET to provide the gate voltage. To couple the accessory input 106 to ground 110, the threshold voltage for Vᵢₙ is selected such that a DC voltage on the accessory input 106, which exceeds the threshold voltage, will produce a Vₒᵤₜ (i.e., a gate voltage on the N-Channel MOSFET) that exceeds the threshold gate voltage (Vₜₕ) of the MOSFET, causing the N-Channel MOSFET to turn on and connect the accessory input 106 to ground 110 through the N-Channel MOSFET channel. The N-Channel MOSFET must be selected such that the maximum gate voltage of the N-Channel MOSFET is not exceeded during failsafe operation.

The second fail-safe sub circuit 112B includes substantially identical components as and is configured to operate similarly to the first fail-safe sub circuit 112A.

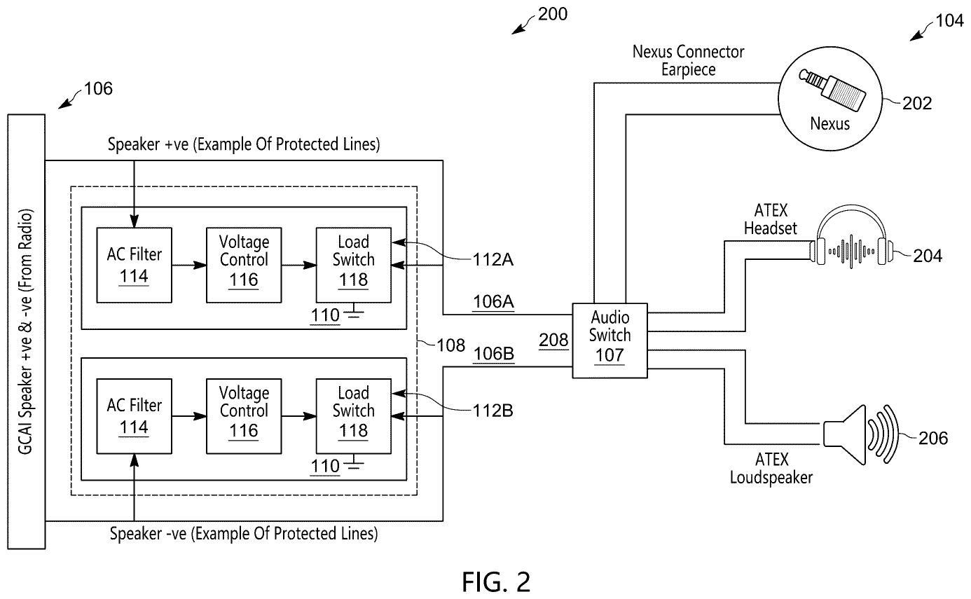

As illustrated in FIG. 2, the fail-safe circuit 108 is comprised of passive components, and therefore does not require any external power supply in order to operate.

FIG. 2 schematically illustrates one example of remote speaker microphone 200. In the example illustrated, the accessory input 106 is a speaker (e.g., audio output) line. The protected components 104 may be, as illustrated, a standard NEXUS connector earpiece 202, an ATEX compliant headset 204, and/or an ATEX compliant 16 Ω loudspeaker 206. As illustrated in FIG. 2, the protected components 104 are coupled to the accessory input 106 via an audio switch 107 at a first point 208. The fail-safe circuit 108 is coupled to the accessory input 106 and configured to shunt the accessory input 106 to ground before the first point 208. In this way, the fail-safe circuit 108 provides protection to all components of the remote speaker microphone 200 located downstream of the first point 208.

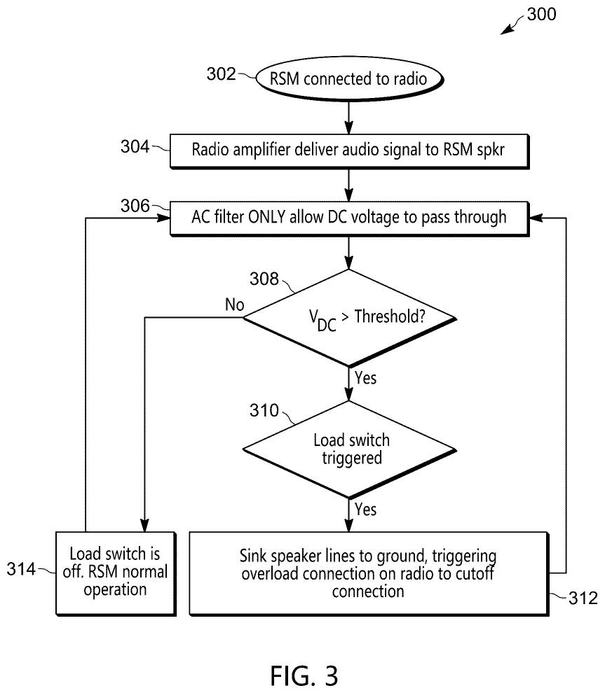

FIG. 3 illustrates an example method 300 for protecting a radio accessory device using the fail-safe circuit of FIG. 1. By way of example, the method 300 is described in terms of a remote speaker microphone (RSM) (e.g., the RSM 200). It should be understood that the method 300 and the examples described herein are applicable to other types of radio accessory devices.

The method 300 begins, at block 302, with the RSM 200 being connected to the radio 102. At block 304, the radio 102 delivers audio signals across positive and negative speaker inputs (e.g., the input lines 106A, 106B) to the RSM 200, to produce sound on, for example, the ATEX loudspeaker 206.

At block 306, the AC filter 114 operates, as described herein, to prevent audio signals from reaching the voltage control circuit 118, while allowing DC voltage to pass through. This prevents a strong audio signal from triggering a false positive fail-safe operation.

At block 308, the voltage control circuit 116 determines whether the DC voltage exceeds the threshold voltage. For example, the threshold may be set at 5V. Where the threshold is exceeded, at block 310, the voltage control circuit 116 produces an output voltage (V_{OUT}) that triggers the load switch 118, which causes the speaker lines (106A, 106B) to sink to ground (at block 312), triggering overcurrent protection on the radio 102 and protecting the protected components 104.

Alternatively, where the voltage threshold is not exceeded (at block 308), the load switch 118 remains off and the RSM 200 operates normally.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . .a,” “has . . .a,” “includes . . .a,” or “contains . . .a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one. ” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

Also, it should be understood that the illustrated components, unless explicitly described to the contrary, may be combined or divided into separate software, firmware, and/or hardware. For example, instead of being located within and performed by a single electronic processor, logic and processing described herein may be distributed among multiple electronic processors. Similarly, one or more memory modules and communication channels or networks may be used even if embodiments described or illustrated herein have a single such device or element. Also, regardless of how they are combined or divided, hardware and software components may be located on the same computing device or may be distributed among multiple different devices. Accordingly, in this description and in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. For example, computer program code for carrying out operations of various example embodiments may be written in an object-oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A system for protecting a radio accessory, the system comprising:
an accessory input for the radio accessory;
an electrical ground; and
a fail-safe circuit coupled between the accessory input and the electrical ground;
wherein the fail-safe circuit consists of passive components including:
an AC filter coupled to the accessory input;
a load switch circuit configured to couple the accessory input to the electrical ground when activated; and
a voltage control circuit coupled to the AC filter and the load switch circuit, and configured to activate the load switch circuit when a DC voltage on the accessory input exceeds a threshold.

2. The system of claim 1, further comprising:
a second fail-safe circuit including a second AC filter, a second load switch, and a second voltage control;
wherein:
the accessory input includes a first line and a second line;
the fail-safe circuit is configured to couple one or both of the first line and the second line to the electrical ground; and
the second fail-safe circuit is configured to couple one or both of the first line and the second line to the electrical ground.

3. The system of claim 1, wherein:
the radio accessory includes one or more protected components coupled to the accessory input at a first point; and
the fail-safe circuit is coupled to the accessory input before the first point.

4. The system of claim 3, wherein the one or more protected components include at least one selected from a group consisting of an inductive load and a resistive load.

5. The system of claim 1, wherein:
the accessory input includes a first input line and a second input line; and
the voltage control circuit is configured to sense the DC voltage between the first input line and the second input line.

6. The system of claim 1, wherein the AC filter is configured to filter audio frequencies received from a radio coupled to the accessory input.

7. The system of claim 1, wherein the load switch circuit includes redundant switching components.

8. The system of claim 1, wherein the voltage control circuit includes a voltage divider.

9. The system of claim 1, wherein the threshold is based on a thermal limit for a protected component of the radio accessory.

10. The system of claim 9, wherein the thermal limit is set for compliance with one or more ATEX directives.

11. The system of claim 1, wherein the fail-safe circuit is configured to operate using the DC voltage and without an external power supply.

12. The system of claim 1, wherein the radio accessory is one selected from a group consisting of a remote speaker microphone, a body-worn camera, an adapter device for coupling a two-way radio to a second radio accessory, a sensor, a light, and a siren.

13. A remote speaker microphone accessory, the remote speaker microphone accessory comprising:
an input for coupling the remote speaker microphone to a radio;
an electrical ground; and
a fail-safe circuit coupled between the input and the electrical ground;
wherein the fail-safe circuit consists of passive components including:
an AC filter coupled to the input;
a load switch circuit configured to couple the input to the electrical ground when activated; and
a voltage control circuit coupled to the AC filter and the load switch circuit, and configured to activate the load switch circuit when a DC voltage on the input exceeds a threshold.

14. The remote speaker microphone of claim 13, further comprising:
a second fail-safe circuit including a second AC filter, a second load switch, and a second voltage control;
wherein:
the input includes a first line and a second line;
the fail-safe circuit is configured to couple one or both of the first line and the second line to the electrical ground; and
the second fail-safe circuit is configured to couple one or both of the first line and the second line to the electrical ground.

15. The remote speaker microphone of claim 13, further comprising:
one or more protected components coupled to the input at a first point; and
wherein the fail-safe circuit is coupled to the input before the first point.

16. The remote speaker microphone of claim 15, wherein the one or more protected components include at least one selected from a group consisting of an inductive load and a resistive load.

17. The remote speaker microphone of claim 13, wherein:
the input includes a first input line and a second input line; and
the voltage control circuit is configured to sense the DC voltage between the first input line and the second input line.

18. The remote speaker microphone of claim 13, wherein the input includes an audio input and the AC filter is configured to filter audio frequencies received from a radio coupled to the input.

19. The remote speaker microphone of claim 13, wherein the threshold is based on a thermal limit for a protected component of the remote speaker microphone, and wherein the thermal limit is set for compliance with one or more ATEX directives.

20. The remote speaker microphone of claim 13, wherein the fail-safe circuit is configured to operate using the DC voltage and without an external power supply.
